(19) United States
(12) Patent Application Publication
(10) Pub. No.: US 2025/0005891 A1
(43) Pub. Date: Jan. 2, 2025

(54) REGIONAL BRIGHTNESS CONTROL SCHEME FOR DISPLAY POWER SAVING

(71) Applicant: Intel Corporation, Santa Clara, CA (US)

(72) Inventors: Mallari C. Hanchate, Bangalore (IN); Bharatkumar Mahajan, Bangalore (IN); Manisha Raiguru, Bangalore (IN); Krishna Kishore Nidamanuri, Bangalore (IN)

(21) Appl. No.: 18/343,255

(22) Filed: Jun. 28, 2023

(51) Int. Cl. G06V 10/60; G06T 5/00; G06V 10/25; G09G 3/3208

(52) U.S. Cl. CPC G06V 10/60; G06T 5/70; G06V 10/25; G09G 3/3208; G09G 2320/0626; G09G 2330/021

(57) ABSTRACT

Various embodiments herein provide apparatuses, systems, and methods associated with a region-based power saving scheme for a display, such as an organic light-emitting diode (OLED) display. In embodiments, pixels of an image may be allocated to two or more subsets including a first subset that corresponds to a region of interest (ROI). The two or more subsets may further include a second subset that includes some or all of the pixels that are outside of the ROI. A more aggressive power saving scheme may be applied to the second subset compared with the first subset (which may or may not undergo a power saving scheme). In some embodiments, a saturation level of the pixels of the second subset may be increased in addition to the dimming. Other embodiments may be described and claimed.

### FIELD

Embodiments of the present disclosure relate generally to the technical field of electronic displays, and more particularly to techniques for emissive displays.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure. Unless otherwise indicated herein, the approaches described in this section are not prior art to the claims in the present disclosure and are not admitted to be prior art by inclusion in this section.

The trend in the display industry is toward thinner displays and with a focus on providing the best visual quality with better battery life for battery operated devices such as laptop computers, tablets, and smartphones. Organic light-emitting diode (OLED) displays provide several advantages, including a lower profile and better visual quality than other technologies. One of the major challenges in the mass adoption of OLED display technology in the personal computer (PC) space is the high power consumption on most productivity workloads due to white and/or bright content. Since OLED displays are an emissive display, the power consumption of the display depends on the image content. Though global brightness adjustments provided by the operating system (OS) may reduce the power consumption, this technique impairs the viewability and/or user experience (UX).

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1 schematically illustrates components of a device in accordance with various embodiments.

FIG. 2 illustrates an example OLED power saving technique (OPST) process.

FIG. 3 illustrates an example power saving process for a display, in accordance with various embodiments.

FIG. 4 illustrates an example of the power saving scheme applied to a video conferencing application, in accordance with various embodiments.

FIG. 5 illustrates an example system configured to employ the apparatuses and methods described herein, in accordance with various embodiments.

### DETAILED DESCRIPTION

Various embodiments herein provide a region-based power saving scheme for a display, such as an OLED display. In embodiments, pixels of an image may be allocated to two or more subsets including a first subset that corresponds to a region of interest (ROI). The two or more subsets may further include a second subset that includes some or all of the pixels that are outside of the ROI. A more aggressive power saving scheme may be applied to the second subset compared with the first subset (which may or may not undergo a power saving scheme). For example, in some embodiments, dimming may be applied to all pixels of the second subset of pixels. Alternatively, a more aggressive form of a selective power saving scheme, such as an OLED power saving technology (OPST) scheme, in which selected pixels are dimmed based on a luminance of the pixels, may be applied to the second subset compared with the first subset. In some embodiments, a saturation level of the pixels of the second subset may be increased in addition to the dimming. The increased saturation level may reduce the visual impact to the user from the dimming.

The embodiments herein provide power savings (decreased power consumption) compared with prior techniques. The user's engagement with the display may decrease outside of the ROI (e.g., away from the center of the screen). Accordingly, the techniques may not affect the user's perception of image quality, as demonstrated by user surveys conducted by the present inventors.

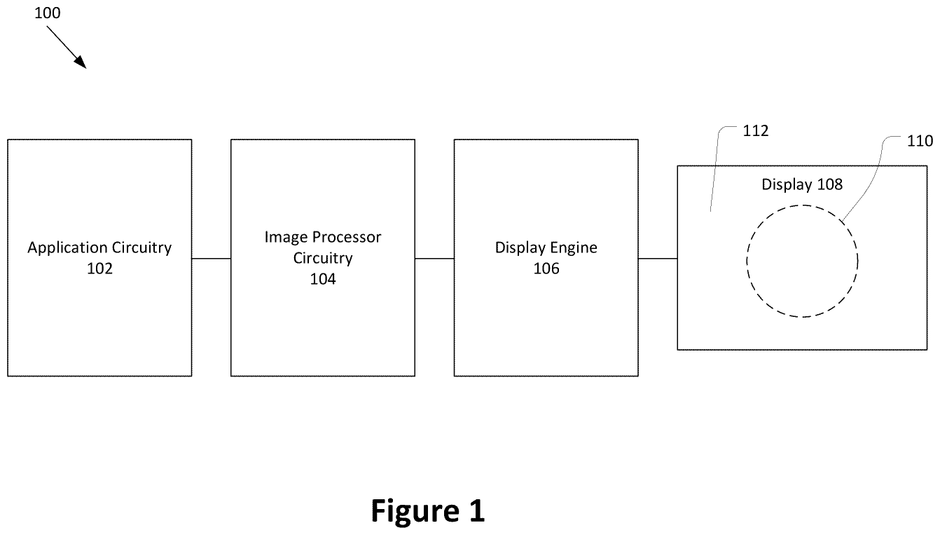

FIG. 1 schematically illustrates components of a device 100 in accordance with various embodiments. The device 100 may include application circuitry 102 to run one or more applications and/or an operating system of the device 100. The device 100 may further include image processor circuitry 104, a display engine 106, and a display 108. The image processor circuitry 104 may receive image information associated with an image to be displayed on the display 108. The image processor circuitry 104 may apply the power saving scheme described herein to the image information, and pass the processed image information to the display engine 106. The display engine 106 may render the image on the display 108.

In various embodiments, the image processor circuitry 104 may allocate pixels of the image to two or more subsets including a first subset that corresponds to a ROI 110. The two or more groups may further include a second subset that includes some or all of the pixels that are outside of the ROI (e.g., corresponding to non-ROI region 112). The image processor circuitry 104 may apply a more aggressive power saving scheme to the second subset compared with the first subset (which may or may not undergo a power saving scheme). For example, in some embodiments, the image processor circuitry 104 may apply dimming to all pixels of the second subset of pixels. Accordingly, the brightness of the pixels of the second subset of pixels may be reduced. The amount of dimming may be predetermined and/or dynamically adjusted (e.g., based on a power saving setting of the display 108 and/or associated device 100). In some embodiments, the image processor circuitry 104 may increase a saturation level of the pixels of the second subset in addition to the dimming. The increased saturation level may reduce the visual impact to the user from the dimming.

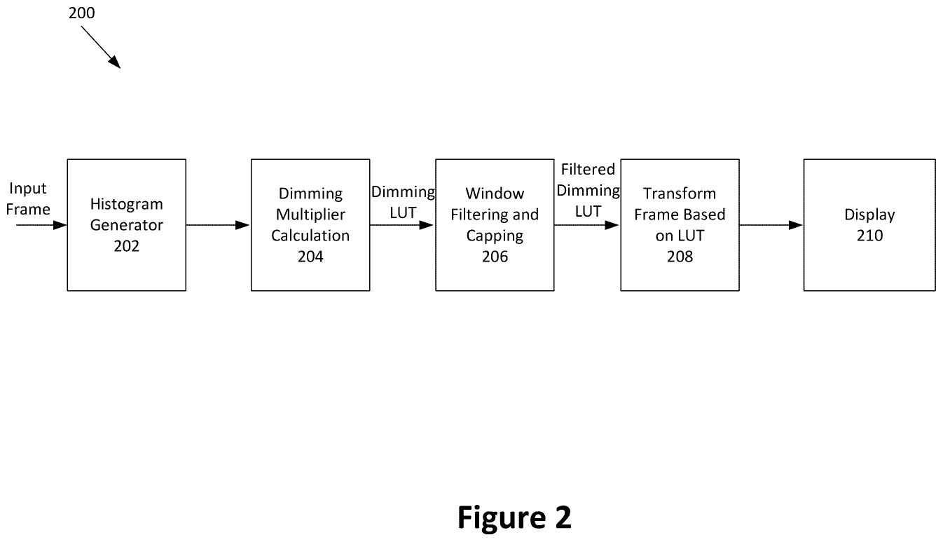

In some embodiments, the image processor circuitry may apply a selective power saving scheme, such as an OLED power saving technology (OPST) scheme, to the first subset of pixels. In the selective power saving scheme, dimming may be selectively applied to some pixels of the first subset based on a luminance of the pixels. OPST is a previously developed technique in which pixels are distributed into bins (e.g., 32 bins) based on a luminance of the respective pixels (e.g., each bin corresponds to a range of luminance values). A group of the bins that correspond to a middle range of luminance (e.g., excluding one or more of the bins that correspond to the highest luminance and one or more of the bins that correspond to the lowest luminance) may be subjected to dimming, while the excluded bins may not be dimmed. The dimmed pixels provide power savings, while excluding the brightest and darkest pixels from dimming maintains the contrast ratio of the image. An example OPST process 200 is illustrated in FIG. 2 and further discussed below.

In some embodiments, instead of dimming all of the pixels of the second subset, the image processor circuitry 104 may apply a more aggressive version of the selective power saving scheme to the second subset compared with the first subset. For example, a wider range of luminance bins may be subjected to dimming and/or the amount of dimming may be greater for the second subset compared with the first subset.

In some embodiments, the image processor circuitry 104 may perform a threshold determination to determine whether to apply the more aggressive power saving scheme (e.g., global dimming and/or the more aggressive version of the selective power saving scheme) to the second subset. For example, the more aggressive power saving scheme may be applied if a percentage of pixels in the second subset that are in a predefined luminance range is greater than a threshold. The predefined luminance range may be a middle range of luminance, e.g., similar to the range used for OPST. The threshold may have any suitable threshold, such as 10 to 50%, e.g., 20%.

In some embodiments, the ROI 110 may correspond to a middle region of the display 108. A user typically focuses on the middle region and is less likely to notice dimming outside of this region. Additionally, or alternatively, the ROI 110 may be determined based on an application that is running on the device 100. For example, an application may include content in certain parts of the screen that the user is likely to focus on and/or are otherwise more important for visual fidelity. The application circuitry 102 may provide ROI information to the image processor circuitry 104 to indicate the ROI 110. In embodiments, the number of pixels included in the first subset (corresponding to the ROI 110) may be based on an aggressiveness level of the power saving scheme. In some embodiments, the aggressiveness level may be dynamically adjusted by the user and/or the operating system (e.g., based on a power source of the device (such as battery or mains power) and/or a remaining battery charge).

In various embodiments, the display 108 may be an emissive display, such as an OLED, and/or another display in which a power consumption of the display depends on the image content (e.g., color, brightness (such as luminance), and/or other aspects of the image). Furthermore, the techniques described herein may be particularly useful for battery-powered devices, such as laptop computers, tablets, smartphones, handheld gaming systems, etc., in which the display is powered by a battery via a battery interface.

As mentioned above, FIG. 2 illustrates an example OPST process 200. At 202, a histogram generator may receive an input frame for an image and generate a global image histogram based on the input frame. The histogram may allocate pixels of the image to respective bins based on the luminance of the pixels. Accordingly, individual bins may correspond to a specific range of luminance values. At 204 of the process 200, a dimming multiplier may be calculated for the respective bins of pixels. For example, dimming may be applied to a set of bins that correspond to a medium luminance range (excluding one or more bins with the brightest luminance and one or more bins with the darkest luminance). A dimming lookup table (LUT) may be generated to indicate the dimming.

At 206, the process 200 may include window filtering and capping. For example, one or more bins that contribute lower power consumption may be filtered out from the dimming process (and thus not dimmed). Additionally, or alternatively, the dimming multiplier for respective bins may be averaged with nearby bins. The window filtering and capping may avoid strong color banding and/or smooth transitions in dimming. The window filtering and capping operation may generate a filtered dimming LUT.

At 208 of the process 200, the image frame may be transformed based on the filtered dimming LUT (e.g., to apply the dimming). At 210, the transformed image frame may be displayed on a display (e.g., OLED). The process 200 may include multiple available levels, e.g., level 1 (L1), level 2 (L2), level 3 (L2), etc., with progressively more aggressive dimming (and thus more power savings). For example, a higher level may include a greater number of bins to which dimming is applied and/or a greater amount of dimming that is applied to the selected bins compared with a lower level.

The process 200 may provide power savings compared to display of the image without selective dimming. However, the process 200 may not provide significant power savings for a bright image. Furthermore, the techniques described herein provide additional power savings compared with the process 200.

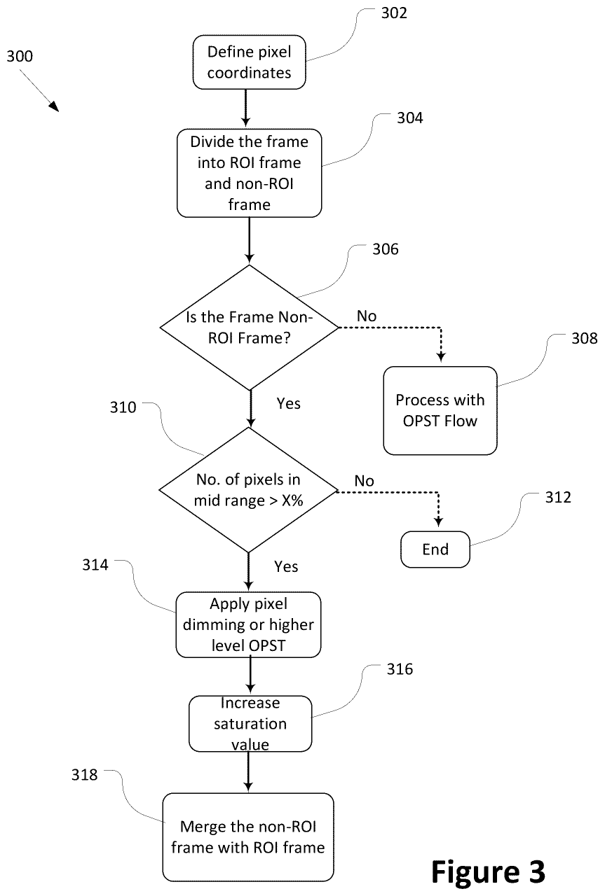

FIG. 3 illustrates an example power saving process 300 in accordance with various embodiments. In some embodiments, the process 300 may be performed by the image processor circuitry 104.

At 302, the process 300 may include determining pixel coordinates of the ROI. As discussed above, the ROI may be predetermined and/or dynamically adjusted, e.g., based on a power saving setting (which may be selected by the user or set by the operating system) and/or an application that is running.

At 304, the pixels of the image frame may be divided into a first subset that corresponds to the ROI (also referred to as the ROI frame) and a second subset that is outside the ROI (also referred to as the non-ROI frame). At 306, the ROI frame and the non-ROI frame may be identified, so that they can be processed accordingly. For example, at 308, the ROI frame may be processed using the selective power saving scheme, e.g., the process 200 of FIG. 2.

At 310, the process 300 may include determining whether a percentage of the pixels in the non-ROI frame that are in a medium range of luminance is greater than a threshold (e.g., 20% in this example). The luminance range and threshold may be predefined or dynamically adjusted (e.g., based on a power saving setting). If the percentage of pixels in the medium range is less than the threshold, then, at 312, the process 300 may end without applying a more aggressive power saving scheme to the non-ROI frame. If the percentage of pixels in the medium range is greater than the threshold, the process 300 may proceed to block 314.

At 314, the process 300 may including applying pixel dimming to the non-ROI frame. The pixel dimming may be global dimming (e.g., dimming applied to all pixels of the non-ROI frame) or a more aggressive version of the selective power saving scheme than is applied to the ROI frame (at 308). For example, the process 300 may define a start pixel coordinate and an end pixel coordinate (or multiple start and end coordinates) and reduce the luminance of the pixels defined by the start and end pixel coordinates. In some embodiments, the luminance of the pixels may be reduced by 30 to 40%, however another amount of dimming may also be used (e.g., 10 to 50%).

At 316, the process 300 may include increasing the saturation value of the pixels in the non-ROI frame. The increased saturation value may reduce and/or eliminate the image degradation perceived by the user.

At 318, the process 300 may include merging the processed non-ROI frame with the processed ROI frame to generate a complete processed image frame. The processed image frame may be provided to a display engine (e.g., display engine 106) for display on the display. The processed image frame may be provided to the display engine via a frame buffer.

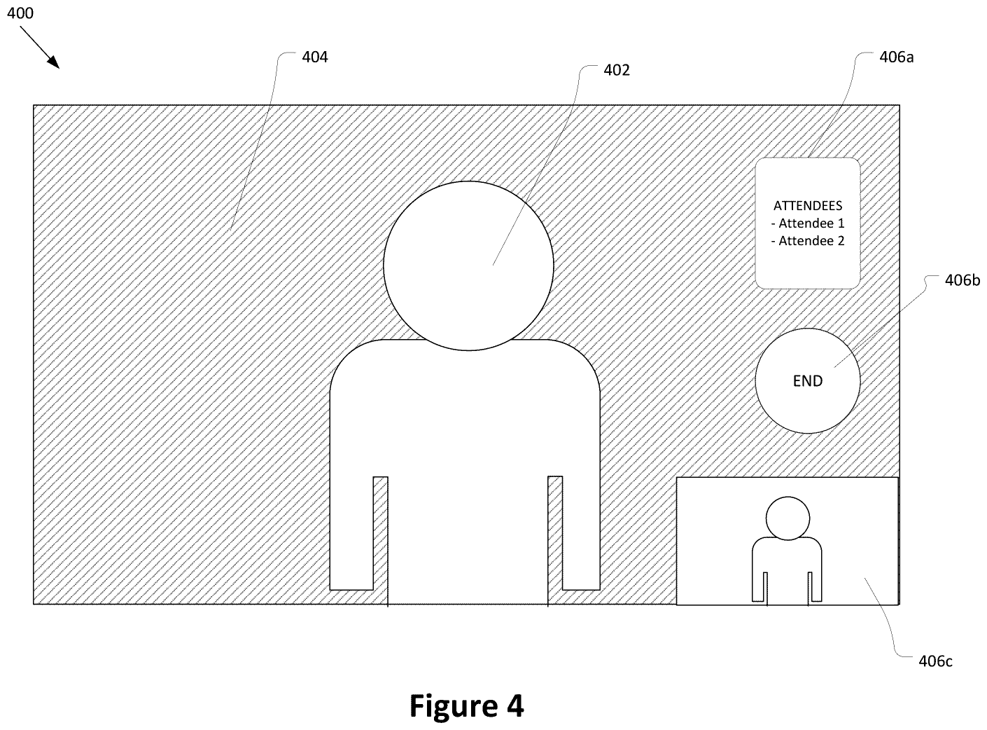

FIG. 4 illustrates an example of a display 400 running a video conferencing application. The image on the display 400 may include a user 402 and a background 404. The user 402 may be a remote user that is meeting with a local user via the video conferencing application. The background 404 may be blurred, e.g., using a setting on the video conferencing application. In embodiments, the region-based power saving scheme described herein may be applied when running the video conferencing application. For example, the region of the display 400 that corresponds to the user 402 may be considered the ROI, and the region that corresponds to the background 404 may be the non-ROI. Accordingly, a more aggressive power saving scheme may be applied to the background 404 compared with the user 402. In some embodiments, the more aggressive power saving scheme may be applied to the background 404 when the background 404 is blurred, but not when the background 404 is not blurred. Alternatively, the more aggressive power saving scheme may be applied to the background 404 whether or not the background 404 is blurred. In some embodiments, a severity of the more aggressive power saving scheme that is applied to the background 404 may be based on whether the background 404 is blurred (e.g., a more sever power saving scheme may be applied to the background 404 when it is blurred compared with when it is not blurred, while both power saving schemes may be more aggressive than the power saving scheme applied to the user 402).

The display may further include overlays 406a-c associated with the video conferencing application, such as attendee information overlay 406a, end button 406b, and thumbnail view 406c of the local user. The overlays 406a-c may or may not be included in the ROT. In some embodiments, the region based power saving scheme may be applied to the thumbnail view 406c, e.g., with the more aggressive power saving scheme applied to the background of the thumbnail view.

Table 1 below illustrates example simulation results, showing power consumption for the region-based power saving scheme compared with the original image and OPST level 2 for five example images. Table 1 further shows the additional power savings (as a percentage) of the region-based power saving scheme compared with OPST level 2.

TABLE 1

| | | | | Additional % |
|---|---|---|---|---|
| | | | | power |
| | | | Region-based | savings from |
| Image | Original | | power | region-based |
| name | image | OPST—L2 | saving scheme | scheme |
| Image1 | 0.324536 | 0.2872 | 0.26173 | 9% |
| Image2 | 0.3688772 | 0.32644 | 0.28607 | 12% |
| Image3 | 0.2963538 | 0.26226 | 0.22887 | 13% |
| Image4 | 0.1766868 | 0.15636 | 0.1326 | 15% |
| Image5 | 0.8870839 | 0.78503 | 0.71363 | 9% |

Table 2 illustrates UX survey results from a survey conducted by the present inventors. The survey results include ratings for OPST and the region-based power saving scheme from five people for five different images. The maximum (positive) rating is 5.

TABLE 2

| | Natural | | | | | | | | Videoconferencing | |
|---|---|---|---|---|---|---|---|---|---|---|
| | Scenery | | Strawberries | | Boy | | Scenethetic | | Application | |
| | | Region | | Region | | Region | | Region | | Region |
| | OPST | based | OPST | based | OPST | based | OPST | based | OPST | based |
| Person 1 | 3.5 | 4 | 5 | 4 | 5 | 4 | 5 | 4 | 5 | 4 |
| Person 2 | 5 | 4.5 | 5 | 4.5 | 5 | 5 | 5 | 4.8 | 5 | 5 |
| Person 3 | 4.8 | 4.7 | 4.8 | 4.7 | 4.8 | 4.7 | 4.8 | 4.7 | 4.8 | 4.6 |
| Person 4 | 4.5 | 4 | 4.5 | 4.25 | 4.5 | 4.5 | 4.5 | 4.25 | 4.5 | 4.5 |
| Person 5 | 5 | 3.5 | 5 | 3.5 | 4 | 5 | 5 | 4 | 4 | 5 |

As can be seen in Table 2, the region-based power saving scheme did not have a significant effect on the users' perception of image quality.

Table 3 illustrates simulation data for a video conferencing application, showing power consumption for a video call without background blur, a video call with background blur, and a video call with the region-based power saving scheme applied. As shown, without the power-saving scheme applied, the video call has substantially the same power consumption with and without background blur. However, applying the region-based power saving scheme provided 31% power savings.

TABLE 3

| Video call | | Region-based | % Savings from |
|---|---|---|---|
| without | Video call with | power saving | Region-based |
| background blur | background blur | scheme | scheme |
| 0.29959 | 0.29692 | 0.203 | 31% |

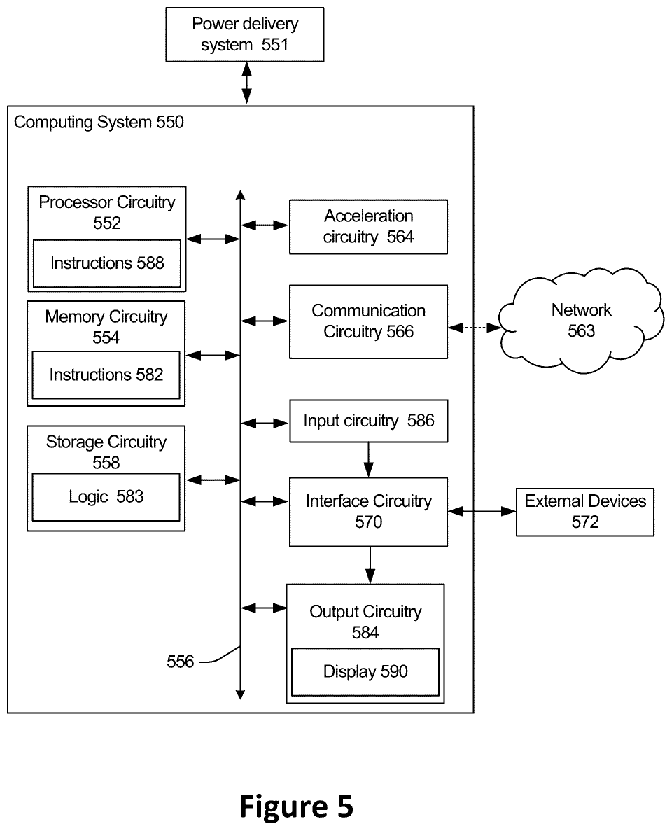

FIG. 5 illustrates an example of components that may be present in a computing system 550 for implementing the apparatuses, systems, and methods described herein. For example, the image processor circuitry and/or region-based power scheme described herein may be implemented in processor circuitry 552, acceleration circuitry 564, interface circuitry 570, and/or output circuitry 584 of computing system 550.

The computing system 550 may be powered by a power delivery subsystem 551 and include any combinations of the hardware or logical components referenced herein. The components may be implemented as ICs, portions thereof, discrete electronic devices, or other modules, instruction sets, programmable logic or algorithms, hardware, hardware accelerators, software, firmware, or a combination thereof adapted in the computing system 550, or as components otherwise incorporated within a chassis of a larger system. For one embodiment, at least one processor 552 may be packaged together with computational logic 582 and configured to practice aspects of various example embodiments described herein to form a System in Package (SiP) or a System on Chip (SoC).

The system 550 includes processor circuitry in the form of one or more processors 552. The processor circuitry 552 includes circuitry such as, but not limited to one or more processor cores and one or more of cache memory, low drop-out voltage regulators (LDOs), interrupt controllers, serial interfaces such as SPI, I2C or universal programmable serial interface circuit, real time clock (RTC), timer-counters including interval and watchdog timers, general purpose I/O, memory card controllers such as secure digital/multi-media card (SD/MMC) or similar, interfaces, mobile industry processor interface (MIPI) interfaces and Joint Test Access Group (JTAG) test access ports. In some implementations, the processor circuitry 552 may include one or more hardware accelerators (e.g., same or similar to acceleration circuitry 564), which may be microprocessors, programmable processing devices (e.g., FPGA, ASIC, etc.), or the like. The one or more accelerators may include, for example, computer vision and/or deep learning accelerators. In some implementations, the processor circuitry 552 may include on-chip memory circuitry, which may include any suitable volatile and/or non-volatile memory, such as DRAM, SRAM, EPROM, EEPROM, Flash memory, solid-state memory, and/or any other type of memory device technology, such as those discussed herein

The processor circuitry 552 may include, for example, one or more processor cores (CPUs), application processors, GPUs, RISC processors, Acorn RISC Machine (ARM) processors, CISC processors, one or more DSPs, one or more FPGAs, one or more PLDs, one or more ASICs, one or more baseband processors, one or more radio-frequency integrated circuits (RFIC), one or more microprocessors or controllers, a multi-core processor, a multithreaded processor, an ultra-low voltage processor, an embedded processor, or any other known processing elements, or any suitable combination thereof. The processors (or cores) 552 may be coupled with or may include memory/storage and may be configured to execute instructions stored in the memory/storage to enable various applications or operating systems to run on the platform 550. The processors (or cores) 552 is configured to operate application software to provide a specific service to a user of the platform 550. In some embodiments, the processor(s) 552 may be a special-purpose processor(s)/controller(s) configured (or configurable) to operate according to the various embodiments herein.

As examples, the processor(s) 552 may include an Intel® Architecture Core™ based processor such as an i3, an i5, an i7, an i9 based processor; an Intel® microcontroller-based processor such as a Quark™, an Atom™, or other MCU-based processor; Pentium® processor(s), Xeon® processor(s), or another such processor available from Intel® Corporation, Santa Clara, California. However, any number other processors may be used, such as one or more of Advanced Micro Devices (AMD) Zen® Architecture such as Ryzen® or EPYC® processor(s), Accelerated Processing Units (APUs), MxGPUs, Epyc® processor(s), or the like; A5-A12 and/or S1-S4 processor(s) from Apple® Inc., Snapdragon™ or Centrig™ processor(s) from Qualcomm® Technologies, Inc., Texas Instruments, Inc.® Open Multimedia Applications Platform (OMAP)™ processor(s); a MIPS-based design from MIPS Technologies, Inc. such as MIPS Warrior M-class, Warrior I-class, and Warrior P-class processors; an ARM-based design licensed from ARM Holdings, Ltd., such as the ARM Cortex-A, Cortex-R, and Cortex-M family of processors; the ThunderX2® provided by Cavium™, Inc.; or the like. In some implementations, the processor(s) 552 may be a part of a system on a chip (SoC), System-in-Package (SiP), a multi-chip package (MCP), and/or the like, in which the processor(s) 552 and other components are formed into a single integrated circuit, or a single package, such as the Edison™ or Galileo™ SoC boards from Intel® Corporation. Other examples of the processor(s) 552 are mentioned elsewhere in the present disclosure.

The system 550 may include or be coupled to acceleration circuitry 564, which may be embodied by one or more AI/ML accelerators, a neural compute stick, neuromorphic hardware, an FPGA, an arrangement of GPUs, one or more SoCs (including programmable SoCs), one or more CPUs, one or more digital signal processors, dedicated ASICs (including programmable ASICs), PLDs such as complex (CPLDs) or high complexity PLDs (HCPLDs), and/or other forms of specialized processors or circuitry designed to accomplish one or more specialized tasks. These tasks may include AI/ML processing (e.g., including training, inferencing, and classification operations), visual data processing, network data processing, object detection, rule analysis, or the like. In FPGA-based implementations, the acceleration circuitry 564 may comprise logic blocks or logic fabric and other interconnected resources that may be programmed (configured) to perform various functions, such as the procedures, methods, functions, etc. of the various embodiments discussed herein. In such implementations, the acceleration circuitry 564 may also include memory cells (e.g., EPROM, EEPROM, flash memory, static memory (e.g., SRAM, anti-fuses, etc.) used to store logic blocks, logic fabric, data, etc. in LUTs and the like.

In some implementations, the processor circuitry 552 and/or acceleration circuitry 564 may include hardware elements specifically tailored for machine learning and/or artificial intelligence (AI) functionality. In these implementations, the processor circuitry 552 and/or acceleration circuitry 564 may be, or may include, an AI engine chip that can run many different kinds of AI instruction sets once loaded with the appropriate weightings and training code. Additionally or alternatively, the processor circuitry 552 and/or acceleration circuitry 564 may be, or may include, AI accelerator(s), which may be one or more of the aforementioned hardware accelerators designed for hardware acceleration of AI applications. As examples, these processor(s) or accelerators may be a cluster of artificial intelligence (AI) GPUs, tensor processing units (TPUs) developed by Google® Inc., Real AI Processors (RAPs™) provided by AlphaICs®, Nervana™ Neural Network Processors (NNPs) provided by Intel® Corp., Intel® Movidius™ Myriad™ X Vision Processing Unit (VPU), NVIDIA® PX™ based GPUs, the NM500 chip provided by General Vision®, Hardware 3 provided by Tesla®, Inc., an Epiphany™ based processor provided by Adapteva®, or the like. In some embodiments, the processor circuitry 552 and/or acceleration circuitry 564 and/or hardware accelerator circuitry may be implemented as AI accelerating co-processor(s), such as the Hexagon DSP provided by Qualcomm®, the PowerVR 2NX Neural Net Accelerator (NNA) provided by Imagination Technologies Limited®, the Neural Engine core within the Apple® A11 or A12 Bionic SoC, the Neural Processing Unit (NPU) within the HiSilicon Kirin 970 provided by Huawei®, and/or the like. In some hardware-based implementations, individual subsystems of system 550 may be operated by the respective AI accelerating co-processor(s), AI GPUs, TPUs, or hardware accelerators (e.g., FPGAs, ASICs, DSPs, SoCs, etc.), etc., that are configured with appropriate logic blocks, bit stream(s), etc. to perform their respective functions.

The system 550 also includes system memory 554. Any number of memory devices may be used to provide for a given amount of system memory. As examples, the memory 554 may be, or include, volatile memory such as random access memory (RAM), static RAM (SRAM), dynamic RAM (DRAM), synchronous DRAM (SDRAM), RAMBUS® Dynamic Random Access Memory (RDRAM®), and/or any other desired type of volatile memory device. Additionally or alternatively, the memory 554 may be, or include, non-volatile memory such as read-only memory (ROM), erasable programmable ROM (EPROM), electrically erasable programmable (EEPROM), flash memory, non-volatile RAM, ferroelectric RAM, phase-change memory (PCM), flash memory, and/or any other desired type of non-volatile memory device. Access to the memory 554 is controlled by a memory controller. The individual memory devices may be of any number of different package types such as single die package (SDP), dual die package (DDP) or quad die package (QDP). Any number of other memory implementations may be used, such as dual inline memory modules (DIMMs) of different varieties including but not limited to microDIMMs or MiniDIMMs.

Storage circuitry 558 provides persistent storage of information such as data, applications, operating systems and so forth. In an example, the storage 558 may be implemented via a solid-state disk drive (SSDD) and/or high-speed electrically erasable memory (commonly referred to as “flash memory”). Other devices that may be used for the storage 558 include flash memory cards, such as SD cards, microSD cards, XD picture cards, and the like, and USB flash drives. In an example, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, phase change RAM (PRAM), resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a Domain Wall (DW) and Spin Orbit Transfer (SOT) based device, a thyristor based memory device, a hard disk drive (HDD), micro HDD, of a combination thereof, and/or any other memory. The memory circuitry 554 and/or storage circuitry 558 may also incorporate three-dimensional (3D) cross-point (XPOINT) memories from Intel and Micron®.

The memory circuitry 554 and/or storage circuitry 558 is/are configured to store computational logic 583 in the form of software, firmware, microcode, or hardware-level instructions to implement the techniques described herein. The computational logic 583 may be employed to store working copies and/or permanent copies of programming instructions, or data to create the programming instructions, for the operation of various components of system 550 (e.g., drivers, libraries, application programming interfaces (APIs), etc.), an operating system of system 550, one or more applications, and/or for carrying out the embodiments discussed herein. The computational logic 583 may be stored or loaded into memory circuitry 554 as instructions 582, or data to create the instructions 582, which are then accessed for execution by the processor circuitry 552 to carry out the functions described herein. The processor circuitry 552 and/or the acceleration circuitry 564 accesses the memory circuitry 554 and/or the storage circuitry 558 over the interconnect (IX) 556. The instructions 582 direct the processor circuitry 552 to perform a specific sequence or flow of actions, for example, as described with respect to flowchart(s) and block diagram(s) of operations and functionality depicted previously. The various elements may be implemented by assembler instructions supported by processor circuitry 552 or high-level languages that may be compiled into instructions 588, or data to create the instructions 588, to be executed by the processor circuitry 552. The permanent copy of the programming instructions may be placed into persistent storage devices of storage circuitry 558 in the factory or in the field through, for example, a distribution medium (not shown), through a communication interface (e.g., from a distribution server (not shown)), over-the-air (OTA), or any combination thereof.

The IX 556 couples the processor 552 to communication circuitry 566 for communications with other devices, such as a remote server (not shown) and the like. The communication circuitry 566 is a hardware element, or collection of hardware elements, used to communicate over one or more networks 563 and/or with other devices. In one example, communication circuitry 566 is, or includes, transceiver circuitry configured to enable wireless communications using any number of frequencies and protocols such as, for example, the Institute of Electrical and Electronics Engineers (IEEE) 802.11 (and/or variants thereof), IEEE 802.23.4, Bluetooth® and/or Bluetooth® low energy (BLE), ZigBee®, LoRaWAN™ (Long Range Wide Area Network), a cellular protocol such as 3GPP LTE and/or Fifth Generation (5G)/New Radio (NR), and/or the like. Additionally or alternatively, communication circuitry 566 is, or includes, one or more network interface controllers (NICs) to enable wired communication using, for example, an Ethernet connection, Controller Area Network (CAN), Local Interconnect Network (LIN), DeviceNet, ControlNet, Data Highway+, or PROFINET, among many others.

The IX 556 also couples the processor 552 to interface circuitry 570 that is used to connect system 550 with one or more external devices 572. The external devices 572 may include, for example, sensors, actuators, positioning circuitry (e.g., global navigation satellite system (GNSS)/Global Positioning System (GPS) circuitry), client devices, servers, network appliances (e.g., switches, hubs, routers, etc.), integrated photonics devices (e.g., optical neural network (ONN) integrated circuit (IC) and/or the like), and/or other like devices.

In some optional examples, various input/output (I/O) devices may be present within or connected to, the system 550, which are referred to as input circuitry 586 and output circuitry 584. The input circuitry 586 and output circuitry 584 include one or more user interfaces designed to enable user interaction with the platform 550 and/or peripheral component interfaces designed to enable peripheral component interaction with the platform 550. Input circuitry 586 may include any physical or virtual means for accepting an input including, inter alia, one or more physical or virtual buttons (e.g., a reset button), a physical keyboard, keypad, mouse, touchpad, touchscreen, microphones, scanner, headset, and/or the like. The output circuitry 584 may be included to show information or otherwise convey information, such as sensor readings, actuator position(s), or other like information. Data and/or graphics may be displayed on one or more user interface components of the output circuitry 584. Output circuitry 584 may include a display 590 (e.g., OLED, Liquid Crystal Displays (LCD), LED displays, quantum dot displays, projectors, etc.) to output of characters, graphics, multimedia objects, and the like generated or produced from the operation of the platform 550. In some embodiments, the display 590 may be a touchscreen display. The interface circuitry 570 and/or another component of the system 550 may implement the region-based power saving scheme described herein for the display 590.

The output circuitry 584 may further include any number and/or combinations of audio or visual display, including, inter alia, one or more simple visual outputs/indicators (e.g., binary status indicators (e.g., light emitting diodes (LEDs)) and/or multi-character visual outputs. The output circuitry 584 may also include speakers and/or other audio emitting devices, printer(s), and/or the like. Additionally or alternatively, sensor(s) may be used as the input circuitry 584 (e.g., an image capture device, motion capture device, or the like) and one or more actuators may be used as the output device circuitry 584 (e.g., an actuator to provide haptic feedback or the like). Peripheral component interfaces may include, but are not limited to, a non-volatile memory port, a USB port, an audio jack, a power supply interface, etc. In some embodiments, a display or console hardware, in the context of the present system, may be used to provide output and receive input of the computing system; to manage components or services of the computing system; identify a state of a computing component or service; or to conduct any other number of management or administration functions or service use cases.

The components of the system 550 may communicate over the IX 556. The IX 556 may include any number of technologies, including ISA, extended ISA, I2C, SPI, point-to-point interfaces, power management bus (PMBus), PCI, PCIe, PCIx, Intel® UPI, Intel® Accelerator Link, Intel® CXL, CAPI, OpenCAPI, Intel® QPI, UPI, Intel® OPA IX, RapidIO™ system IXs, CCIX, Gen-Z Consortium IXs, a HyperTransport interconnect, NVLink provided by NVIDIA®, a Time-Trigger Protocol (TTP) system, a FlexRay system, PROFIBUS, and/or any number of other IX technologies. The IX 556 may be a proprietary bus, for example, used in a SoC based system.

The number, capability, and/or capacity of the elements of system 550 may vary, depending on whether computing system 550 is used as a stationary computing device (e.g., a server computer in a data center, a workstation, a desktop computer, etc.) or a mobile computing device (e.g., a smartphone, tablet computing device, laptop computer, game console, IoT device, etc.). In various implementations, the computing device system 550 may comprise one or more components of a data center, a desktop computer, a workstation, a laptop, a smartphone, a tablet, a digital camera, a smart appliance, a smart home hub, a network appliance, and/or any other device/system that processes data.

The techniques described herein can be performed partially or wholly by software or other instructions provided in a machine-readable storage medium (e.g., memory). The software is stored as processor-executable instructions (e.g., instructions to implement any other processes discussed herein). Instructions associated with the flowchart (and/or various embodiments) and executed to implement embodiments of the disclosed subject matter may be implemented as part of an operating system or a specific application, component, program, object, module, routine, or other sequence of instructions or organization of sequences of instructions.

The storage medium can be a tangible machine readable medium such as read only memory (ROM), random access memory (RAM), flash memory devices, floppy and other removable disks, magnetic storage media, optical storage media (e.g., Compact Disk Read-Only Memory (CD ROMS), Digital Versatile Disks (DVDs)), among others.

The storage medium may be included, e.g., in a communication device, a computing device, a network device, a personal digital assistant, a manufacturing tool, a mobile communication device, a cellular phone, a notebook computer, a tablet, a game console, a set top box, an embedded system, a TV (television), or a personal desktop computer.

### EXAMPLES

Some non-limiting examples of various embodiments are provided below.

Example 1 includes an apparatus comprising an image processor circuitry to: receive image data for an image to be rendered on a display; determine a region of interest (ROI) of the image; identify a first set of pixels that corresponds to the ROI, and a second set of pixels that are outside of the ROI; apply a first dimming scheme to the first set of pixels to generate a first set of processed pixels; apply a second dimming scheme to the second set of pixels to generate a second set of processed pixels; and merge the first set of processed pixels with the second set of processed pixels to generate processed image data. The apparatus further comprises a display engine to render the image on the display based on the processed image data.

Example 2 includes the apparatus of example 1, wherein to apply the second dimming scheme includes to apply dimming to all pixels of the second set of pixels.

Example 3 includes the apparatus of example 1 or 2, wherein to apply the second dimming scheme further includes to increase a saturation level of the pixels of the second set of pixels.

Example 4 includes the apparatus of any one of examples 1-3, wherein the first dimming scheme includes to selectively apply dimming to only some pixels of the first set of pixels based on a luminance of the respective pixels of the first set of pixels.

Example 5 includes the apparatus of any one of examples 1-4, wherein the second dimming scheme is applied to the second set of pixels based on a determination that a percentage of the pixels of the second set of pixels that are within a predefined luminance range is greater than a threshold.

Example 6 includes the apparatus of any one of examples 1-5, wherein the ROI is determined based on a power saving setting of the apparatus or based on an application being run by the apparatus.

Example 7 includes the apparatus of example 6, wherein the application is a video conferencing application, and wherein the second set of pixels corresponds to a blurred background region of the image.

Example 8 includes the apparatus of any one of examples 1-7, further comprising one or more of: application circuitry to provide the image data to the image processor circuitry; or a memory to store instructions for the first dimming scheme and the second dimming scheme.

Example 9 includes the apparatus of any one of examples 1-8, wherein the display is an organic light emitting diode (OLED) display.

Example 10 includes one or more non-transitory computer-readable media (NTCRM) having instructions, stored thereon, that when executed by one or more processors of a device configure the device to: obtain image information associated with an image to be displayed on a display of the device; allocate pixels of the image to a first subset of pixels and a second subset of pixels, wherein the first subset of pixels corresponds to a region of interest (ROI) of the image; apply dimming to all pixels of the second subset of pixels; and merge the dimmed pixels of the second subset of pixels with the first subset of pixels for display.

Example 11 includes the one or more NTCRM of example 10, wherein the instructions, when executed, further configure the device to selectively apply dimming to only some of the first subset of pixels based on a luminance of the respective pixels of the first subset of pixels.

Example 12 includes the one or more NTCRM of example 10 or 11, wherein the instructions, when executed, further configure the device to increase a saturation of the pixels of the second subset of pixels.

Example 13 includes the one or more NTCRM of any one of examples 10-12, wherein the dimming is applied based on a determination that a percentage of the pixels of the second subset of pixels that are within a predefined luminance range is greater than a threshold.

Example 14 includes the one or more NTCRM of any one of examples 10-13, wherein the number of pixels included in the first subset of pixels is based on an aggressiveness level.

Example 15 includes the one or more NTCRM of example 14, wherein the aggressiveness level is user selectable.

Example 16 includes the one or more NTCRM of any one of examples 10-15, wherein the second subset of pixels corresponds to a blurred background region of the image.

Example 17 includes the one or more NTCRM of any one of examples 10-16, wherein the display is an organic light emitting diode (OLED) display.

Example 18 includes a device comprising: a display; a battery interface to provide power to the display; and an image processor coupled to the display. The image processor is to: receive image information associated with an image to be displayed on the display; determine a region of interest (ROI) associated with the image; allocate pixels of the image to a first subset of pixels and a second subset of pixels, wherein the first subset of pixels corresponds to the ROI and the second subset of pixels is outside of the ROI; apply a selective power saving scheme to the first subset of pixels based on a luminance of respective pixels of the first subset of pixels to generate a processed ROI frame; apply dimming to all pixels of the second subset of pixels to generate a non-ROI frame; merge the ROI frame with the non-ROI frame to generate a merged frame; and provide the merged frame to the display.

Example 19 includes the device of example 18, wherein the image processor is further to increase a saturation of the pixels of the second subset of pixels.

Example 20 includes the device of example 18 or 19, wherein the image processor is to apply dimming to all pixels of the second subset of pixels based on a determination that a percentage of the pixels of the second subset of pixels that are within a predefined luminance range is greater than a threshold.

Example 21 includes the device of any one of examples 18-20, further comprising one or more of: application circuitry to provide the image information to the image processor; a memory to store media content associated with the image; or interface circuitry to interface the image processor with the display.

Example 22 includes a method comprising: obtaining image information associated with an image to be displayed on a display; allocating pixels of the image to a first subset of pixels and a second subset of pixels, wherein the first subset of pixels corresponds to a region of interest (ROI) of the image; applying dimming to all pixels of the second subset of pixels; and merging the dimmed pixels of the second subset of pixels with the first subset of pixels for display.

Example 23 includes the method of example 22, further comprising selectively applying dimming to only some of the first subset of pixels based on a luminance of the respective pixels of the first subset of pixels.

Example 24 includes the method of example 22 or 23, further comprising increasing a saturation of the pixels of the second subset of pixels.

Example 25 includes the method of any one of examples 22-24, wherein the dimming is applied based on a determination that a percentage of the pixels of the second subset of pixels that are within a predefined luminance range is greater than a threshold.

Example 26 includes the method of any one of examples 22-25, wherein the number of pixels included in the first subset of pixels is based on an aggressiveness level.

Example 27 includes the method of example 26, wherein the aggressiveness level is user selectable.

Example 28 includes the method of any one of examples 22-27, wherein the second subset of pixels corresponds to a blurred background region of the image.

Example 29 includes the method of any one of examples 22-28, wherein the display is an organic light emitting diode (OLED) display.

Example 30 includes an apparatus comprising means to perform the method of any one of examples 22-29.

In the preceding detailed description, reference is made to the accompanying drawings that form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

The terms “substantially,” “close,” “approximately,” “near,” and “about,” generally refer to being within +/−10% of a target value. Unless otherwise specified the use of the ordinal adjectives “first,” “second,” and “third,” etc., to describe a common object, merely indicate that different instances of like objects are being referred to, and are not intended to imply that the objects so described must be in a given sequence, either temporally, spatially, in ranking or in any other manner.

For the purposes of the present disclosure, the phrases “A and/or B” and “A or B” mean (A), (B), or (A and B). For the purposes of the present disclosure, the phrase “A, B, and/or C” means (A), (B), (C), (A and B), (A and C), (B and C), or (A, B, and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the term “circuitry” may refer to, be part of, or include an Application Specific Integrated Circuit (ASIC), an electronic circuit, a processor (shared, dedicated, or group), a combinational logic circuit, and/or other suitable hardware components that provide the described functionality. As used herein, “computer-implemented method” may refer to any method executed by one or more processors, a computer system having one or more processors, a mobile device such as a smartphone (which may include one or more processors), a tablet, a laptop computer, a set-top box, a gaming console, and so forth.

Although certain embodiments have been illustrated and described herein for purposes of description, this application is intended to cover any adaptations or variations of the embodiments discussed herein. Therefore, it is manifestly intended that embodiments described herein be limited only by the claims.

Where the disclosure recites “a” or “a first” element or the equivalent thereof, such disclosure includes one or more such elements, neither requiring nor excluding two or more such elements. Further, ordinal indicators (e.g., first, second, or third) for identified elements are used to distinguish between the elements, and do not indicate or imply a required or limited number of such elements, nor do they indicate a particular position or order of such elements unless otherwise specifically stated.

What is claimed is:

1. An apparatus comprising:
an image processor circuitry to:
receive image data for an image to be rendered on a display;
determine a region of interest (ROI) of the image;
identify a first set of pixels that corresponds to the ROI, and a second set of pixels that are outside of the ROI;
apply a first dimming scheme to the first set of pixels to generate a first set of processed pixels;
apply a second dimming scheme to the second set of pixels to generate a second set of processed pixels; and
merge the first set of processed pixels with the second set of processed pixels to generate processed image data; and
a display engine to render the image on the display based on the processed image data.

2. The apparatus of claim 1, wherein to apply the second dimming scheme includes to apply dimming to all pixels of the second set of pixels.

3. The apparatus of claim 2, wherein to apply the second dimming scheme further includes to increase a saturation level of the pixels of the second set of pixels.

4. The apparatus of claim 1, wherein the first dimming scheme includes to selectively apply dimming to only some pixels of the first set of pixels based on a luminance of the respective pixels of the first set of pixels.

5. The apparatus of claim 1, wherein the second dimming scheme is applied to the second set of pixels based on a determination that a percentage of the pixels of the second set of pixels that are within a predefined luminance range is greater than a threshold.

6. The apparatus of claim 1, wherein the ROI is determined based on a power saving setting of the apparatus or an application being run by the apparatus.

7. The apparatus of claim 6, wherein the application is a video conferencing application, and wherein the second set of pixels corresponds to a blurred background region of the image.

8. The apparatus of claim 1, further comprising one or more of:
application circuitry to provide the image data to the image processor circuitry; or
a memory to store instructions for the first dimming scheme and the second dimming scheme.

9. The apparatus of claim 1, wherein the display is an organic light emitting diode (OLED) display.

10. One or more non-transitory computer-readable media (NTCRM) having instructions, stored thereon, that when executed by one or more processors of a device configure the device to:
obtain image information associated with an image to be displayed on a display of the device;
allocate pixels of the image to a first subset of pixels and a second subset of pixels, wherein the first subset of pixels corresponds to a region of interest (ROI) of the image;
apply dimming to all pixels of the second subset of pixels; and
merge the dimmed pixels of the second subset of pixels with the first subset of pixels for display.

11. The one or more NTCRM of claim 10, wherein the instructions, when executed, further configure the device to:
selectively apply dimming to only some of the first subset of pixels based on a luminance of the respective pixels of the first subset of pixels.

12. The one or more NTCRM of claim 10, wherein the instructions, when executed, further configure the device to increase a saturation of the pixels of the second subset of pixels.

13. The one or more NTCRM of claim 10, wherein the dimming is applied based on a determination that a percentage of the pixels of the second subset of pixels that are within a predefined luminance range is greater than a threshold.

14. The one or more NTCRM of claim 10, wherein the number of pixels included in the first subset of pixels is based on an aggressiveness level, and wherein the aggressiveness level is user selectable.

15. The one or more NTCRM of claim 10, wherein the second subset of pixels corresponds to a blurred background region of the image.

16. The one or more NTCRM of claim 10, wherein the display is an organic light emitting diode (OLED) display.

17. A device comprising:
a display;
an image processor coupled to the display, the image processor to:
receive image information associated with an image to be displayed on the display;
determine a region of interest (ROI) associated with the image;
allocate pixels of the image to a first subset of pixels and a second subset of pixels, wherein the first subset of pixels corresponds to the ROI and the second subset of pixels is outside of the ROI;
apply a selective power saving scheme to the first subset of pixels based on a luminance of respective pixels of the first subset of pixels to generate a processed ROI frame;
apply dimming to all pixels of the second subset of pixels to generate a non-ROI frame;
merge the ROI frame with the non-ROI frame to generate a merged frame; and
provide the merged frame to the display.

18. The device of claim 17, wherein the image processor is further to increase a saturation of the pixels of the second subset of pixels.

19. The device of claim 17, wherein the image processor is to apply dimming to all pixels of the second subset of pixels based on a determination that a percentage of the pixels of the second subset of pixels that are within a predefined luminance range is greater than a threshold.

20. The device of claim 17, further comprising one or more of:
application circuitry to provide the image information to the image processor;
a memory to store media content associated with the image; or
interface circuitry to interface the image processor with the display.
